(19) United States
(12) Patent Application Publication
(10) Pub. No.: US 2015/0037695 A1
(43) Pub. Date: Feb. 5, 2015

(54) FUEL CELL ELECTROLYTE REGENERATOR AND SEPARATOR

(71) Applicant: ACAL ENERGY LIMITED, Cheshire (GB)

(72) Inventors: David Ward, Cheshire (GB); Robert Longman, Cheshire (GB)

(21) Appl. No.: 14/374,874

(22) PCT Filed: Jan. 25, 2013
(86) PCT No.: PCT/GB2013/050173

§ 371 Date: Jul. 25, 2014

(30) Foreign Application Priority Data
Jan. 25, 2012 (GB) 1201246.4
Feb. 29, 2012 (GB) 1203565.5
Feb. 29, 2012 (GB) 1203567.1

(51) Int. Cl. H01M 8/04; B01D 19/02; B01D 19/00

(52) U.S. Cl. CPC H01M 8/04276; B01D 19/0057; B01D 19/02; H01M 2250/20
USPC 429/409; 96/216; 96/188; 96/202; 96/176; 96/179

(57) ABSTRACT

The invention concerns in one aspect, a separator (100, 200, 300) for a liquid electrolyte regenerator of a fuel cell system and, in another aspect, a foam reducing apparatus. In the separator, a helical fluid channel (100, 200, 300) formed on a helix (150) is arranged to conduct liquid and gas of a gas-liquid mixture and separate the liquid from the gas-liquid mixture. The helical channel (100, 200, 300) may be an enclosed channel or pipe (210, 302) and the overall diameter (D_{HELIX}) of the helical channel may be around twice the pipe diameter. The helical channel can form part of a bulk gas-liquid separator (200), or a gas-liquid contactor and separator (300, 400, 500), or a condensing heat exchanger (300, 400, 500). The foam reduction apparatus (FIG. 15 155, 157; FIG. 20; FIG. 16, 1600; FIG. 18, 1800), has a low surface energy material and is arranged to provide contact between foam and a surface of the low surface energy material. The separator and the foam reduction apparatus may be used independently or in combination to good effect so as to provide more efficient disruption of foam to provide separate gas and liquid phases.

The present invention relates to an indirect or redox fuel cell system, and in particular to a liquid electrolyte regenerator and separator for such an indirect or redox fuel cell system.

Fuel cells have applications in stationary, back-up and combined heat and power (CHP) contexts, as well as in fuel cells for the automotive industry and in micro fuel cells for electronic and portable electronic devices.

Fuel cells are devices that produce electrical energy using the chemical properties of a fuel (often hydrogen) and oxygen to directly create electrical current. They are technically similar to a battery although, unlike a battery, they do not store energy but produce electrical energy from an external fuel source as required.

Fuel cells were initially demonstrated in 1839, by Sir William Grove, however, a truly workable fuel cell was not demonstrated until 1959. After use in NASA's space programme, interest in fuel cells decreased until the 1990s when they were considered as a replacement for combustion engines because of their potential to be a more efficient and clean way to create power. Fuel Cells now find use in a range of applications such as transport, stationary power and even laptop computers.

In its simplest form, a fuel cell is an electrochemical energy conversion device that converts fuel and oxidant into reaction product(s), producing electrical energy and heat energy in the process. When hydrogen is used as fuel and air or oxygen as oxidant, the products of the reaction are water and heat. The hydrogen and air/oxygen gases are fed respectively into catalysing, diffusion-type anode and cathode electrodes separated by a solid or liquid electrolyte which carries electrically charged particles between the two electrodes.

In an indirect or redox fuel cell, the oxidant (and/or fuel in some cases) is not reacted directly at the electrode but instead reacts with the reduced form (oxidized form for fuel) of a redox couple to oxidise it, and this oxidised species is fed to the cathode.

There are a number of types of fuel cell which are normally distinguished by the electrolyte they contain. The best-known types are alkaline, molten carbonate, phosphoric acid, solid oxide and Proton Exchange Membranes (PEM). PEM membranes include Polymer Electrolyte Membranes. Direct methanol and regenerative fuel cells are the subject of extensive research. Fuel cells utilising alkali electrolyte have an inherent disadvantage in that the electrolyte dissolves CO₂ and therefore needs to be replaced periodically. Polymer electrolyte or PEM-type cells with proton-conducting solid cell membranes are acidic and avoid this problem.

PEM fuel cells are used in automobiles. Most fuel cells used in vehicles produce less than 1.16 volts of electricity which is not enough to power a vehicle. Therefore, multiple cells are assembled into a fuel cell stack. The potential power generated by a fuel cell stack depends on the surface area of the membrane in each cell and the total number of the individual fuel cells that comprise the stack.

A PEM fuel cell comprises a polymer electrolyte membrane (PEM) sandwiched between an anode and a cathode. Anode and cathode flow plates are attached to the anode and cathode respectively via respective backing layers. The anode flow plate acts to distribute hydrogen across the anode. The cathode flow plate 110 distributes oxygen/air across the cathode and channels water as a by-product away from the cathode and provides heat as another by-product. An electrical current flows between the cathode and anode flow plates.

The anode typically comprises platinum particles uniformly supported on carbon particles. The platinum acts as a catalyst by increasing the rate of the oxidation process. The anode is porous so that the hydrogen fuel can pass through it. Similarly, the cathode too typically comprises platinum particles uniformly supported on carbon particles. The platinum of the cathode acts as a catalyst by increasing the rate of the reduction process. The cathode is porous so that oxygen can pass through it.

A problem exists in that it has proved difficult in practice to attain power outputs from such PEM-type fuel cells approaching the theoretical maximum level, due to the relatively poor electrocatalysis of the oxygen reduction reaction. A further problem is that expensive noble metal electrocatalysts such as platinum are often used, causing a significant cost impact.

A recently-developed technology addresses these problems and promises to make PEM fuel cells competitive with conventional electricity generators, such as diesel generators, by replacing the fixed platinum catalysts on the cathode with a liquid regenerating catalyst system.

Such a liquid regenerating catalyst system is described in international published patent application WO2010128333, the contents of which are incorporated herein by reference.

In a known liquid regenerating catalyst system, liquid electrolyte (‘catholyte’) is continuously pumped through the fuel cell, by a pump into a regenerator and then back to the fuel cell. Air is forced by a blower into the regenerator at an input port and air (depleted of oxygen), water vapour and heat are output from the regenerator at an output port. As well as providing gas-liquid contacting, the regenerator also includes a gas-liquid separator which allows the regenerator to remove air/oxygen from the catholyte and return the catholyte, substantially free of air/oxygen, to the stack.

This liquid electrolyte regenerating technology reduces platinum content by up to 80% and simplifies the overall fuel cell system. As a consequence the technology not only radically reduces cost, it also improves durability and robustness of the system. This technology overcomes the three major limitations associated with conventional PEM fuel cell operation, namely catalyst loading, catalyst agglomeration and heat management. Additionally, a peak performance power density of nearly 900 mW/cm² has been achieved, which is a substantial improvement over a previously announced peak power record of around 600 mW/cm².

A known redox reaction occurs within a fuel cell of the liquid regenerating catalyst systems described above. The composition of a redox mediator couple and/or a redox catalyst of the redox reaction has been described in international patent applications having publication numbers WO/2007/110663, WO/2009/040577, WO/2008/009993, WO/2009/093080, WO/2009/093082, WO/2008/009992 and WO/2009/093081, the contents of which are incorporated herein by reference.

In order to regenerate the liquid electrolyte (catholyte) in the liquid regenerating catalyst system, it is necessary to create a large gas-liquid interfacial area to enable the reaction together of sufficient electrons, protons and oxygen molecules to form the oxidized catholyte and the water by-product. This can be achieved by the creation of gas bubbles in the liquid stream or liquid droplets in a gas stream (both these methods being known generally as gas-liquid contacting). The total surface area of the gas bubbles is maintained for sufficient time to achieve sufficient mass transfer, after which separation of the gas and liquid streams is performed as rapidly as possible with minimal energy input. This separation is done prior to the input of the liquid electrolyte into the fuel cell so as to provide good operation of the fuel cell.

Therefore, a bubble generator for a liquid electrolyte fuel cell system is arranged to input liquid electrolyte and gas, to generate gas bubbles in the liquid electrolyte and to output the liquid and gas in bubble form.

Preferably most of the electrolyte liquid output from the cathode region is converted into a foam form by the formation of bubbles within it. The bubbles greatly speed the re-oxidation of the electrolyte liquid during the regeneration process, prior to the electrolyte being input once again to the PEM fuel cell.

The fuel cell uses cathode electrolyte (catholyte) in liquid form, and best performance of the fuel cell is obtained when the electrolyte at the cathode is free of gas. However, as explained above, the electrolyte output from the regenerator is mixed with air and then contains a significant proportion of gas and is preferably in a bubbled or foamed form.

Cyclonic separation is a known method of separating fine particles from a gaseous (or liquid) stream without the use of filters, through vortex separation. The combination of centrifugal effects and gravity are used to separate mixtures of solids and gas, and/or solids and liquid, and/or liquid and gas.

International patent application WO2009006672 describes a gas-liquid separator used in the petroleum industry, in which an input mixture of fluids flows downward in an outer pipe along a spiral guide vane such that a gas and a liquid are separated centrifugally.

In cyclonic separation, a high speed rotating (gas) flow is established within a cylindrical or conical container called a cyclone. Air flows in a helical pattern, beginning at the top (wide end) of the cyclone and ending at the bottom (narrow) end before exiting the cyclone upwards in a straight stream through the centre of the cyclone and out of the top. Larger (denser) particles in the rotating stream have too much inertia to follow the tight curve of the stream, and strike the outside wall, then falling to the bottom of the cyclone where they can be removed. In a conical cyclone, as the rotating flow moves towards the narrow end of the cyclone, the rotational radius of the stream is reduced, thus separating smaller and smaller particles. Such conical cyclones find application in sawmills, vacuum cleaners, and in the separation of gas and liquid in a gas-liquid mixture.

However, tests with conical cyclones have shown poor performance when attempting to separate gas-liquid foams when the gas-liquid ratio is approximately 4:1, as is required in the liquid electrolyte regeneration system for best performance of the regenerator. High values of g (acceleration) are required to break down such foams, requiring a large amount of energy to accelerate the two phase mixture, giving rise to large operational cost due to parasitic power loss. Also very high carry-over of liquid into the gas stream and carry-under of gas into the liquid have been observed as a result of inadequate downward momentum of the liquid stream. These problems can be partly reduced by utilising a Gas Liquid Cylindrical Cyclone (GLCC).

A known gas liquid cylindrical cyclone was developed by Chevron and the University of Tulsa for the purpose of separation of oil and gas (e.g. Rosa, E, The cyclone gas-liquid separator: operation and mechanistic modelling, Journal of Petroleum Science and Engineering 32, 87-101 (2001)). In one design a gas-liquid mixture enters a cyclone at an input port, gas exits at an upper output port and the liquid is extracted tangentially from the cyclone at a lower output port thereby increasing the diameter of the gas vortex and improving separation.

A problem arises with such a cyclone separator: the time (residence time′) during which the liquid is under high g conditions is limited. This is partly because the fluid velocity is slowed by wall drag and by separation of the gas. However, the predominant mechanism for limited residence time is the effect of gravity dragging the fluid out of the cylindrical section of the cyclone. These two mechanisms for fluid slowing result in a downward motion, instead of radially outward motion (as desired). To some extent this can be offset by increasing the tangential inlet velocity but doing this requires extra pumping energy which adds increased pressure drop which in turn costs more (both energetically and financially).

It is an object of the invention to provide an improved fuel cell electrolyte regenerator that addresses the above-described problems and limitations and, in particular, to provide a regenerator that is capable of separating gas and liquid contained in a gas-liquid mixture as rapidly as possible with minimal energy input. This is particularly desirable in the case of a gas-liquid mixture where a large gas-to-liquid ratio is employed (for example, ten times as much air as liquid, which results in a “dry foam”). Such a case conventionally requires a more energy or time intensive separation process due to the domination of surface tension effects on coalescence.

In attempting to address the above problems and limitations, it has been found that better performance can be obtained by inducing spiral flow of the two phase gas-liquid mixture and additionally constraining the flow of the mixture within an enclosed helical channel (i.e. a pipe rather than an open cylinder). By doing this, a high gravitational separating force (represented by effective acceleration g_{eff}) can be sustained for a longer time interval, achieving more effective bubble collapse and therefore faster separation of gas and liquid.

This technique is particularly effective in breaking down a gas-liquid mixture in the form of foam (comprising bubbles), said foam containing liquid (electrolyte) and air/oxygen. However, it should be understood that the technique is also capable of providing improved separation of gas and liquid of a gas-liquid mixture when the gas-liquid mixture comprises little or no foam or bubbles, or indeed a two phase mixture of immiscible liquids which display a difference in density (i.e. liquid-liquid separation).

According to an aspect of the invention, therefore, there is provided a separator for a liquid electrolyte regenerator of a fuel cell system, the separator comprising a helical channel in the form of a fluid channel formed on a helix and arranged to conduct a gas-liquid mixture and separate liquid from the gas-liquid mixture.

According to another aspect of the invention there is provided a foam reduction apparatus comprising a low surface energy material and means for contacting foam, when said foam is input to the foam reduction apparatus, along a surface of said low surface energy material.

At least a portion of the surface of said low surface energy material may be convex or pointed so that it is projecting away from other portions of the surface.

Such a portion of the surface of said low surface energy material may be formed by plural convex regions on the surface.

The portion may be formed by elongate strands of a mesh structure.

The surface, or surfaces, may be oriented at least partly parallel to a direction of flow of fluid past the surface(s).

The, or each, surface may comprise flexible material and may be held at or proximal to its/their upstream end(s), so as to inhibit movement of its upstream end whilst permitting lateral movement of a portion of the surface distal from its upstream end.

The surface may comprise a plurality of surfaces which are held in position proximal to one another so that they are at least partly parallel to one another and to the primary direction of fluid flow at their respective upstream ends.

The plurality of surfaces may be held in position so that they are spaced apart from one another in a direction transversal to the primary direction of fluid flow.

The plurality of surfaces may be attached to one another along an axis at least partly parallel to the primary direction of fluid flow and held in position so that they each extend from said axis radially outward from said axis.

A gas-liquid separating apparatus may be provided, comprising a separator according to the first aspect of the invention, and a foam reduction apparatus according to the other aspect of the invention.

A fuel cell system comprising a separator and/or a foam reducing apparatus as described herein may be used for the combined generation of heat and power, to provide motive power to a vehicle, or to generate power in an electronic apparatus, or any combination of two or more of such uses can be provided.

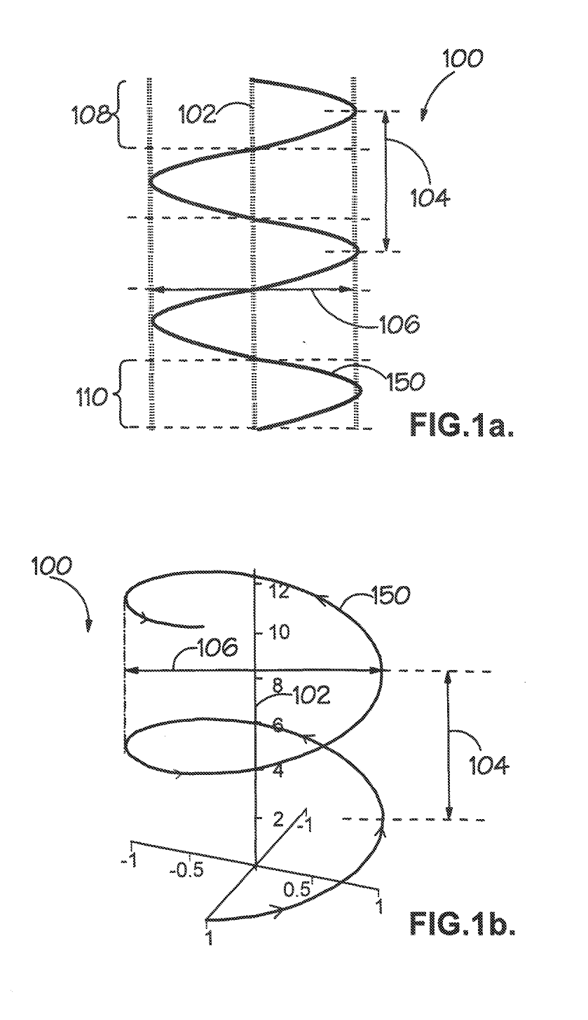

The above and further aspects of the invention will now be described in the following detailed description of preferred embodiments of the invention which are illustrated, by way of example only, in FIGS. 1 to 5 of the accompanying drawings, in which:

FIG. 1 is a simplified view of a helix of a helical channel for use in a liquid catalyst fuel cell. FIG. 1a is a side view of the helix and FIG. 1 b is a perspective view of the helix.

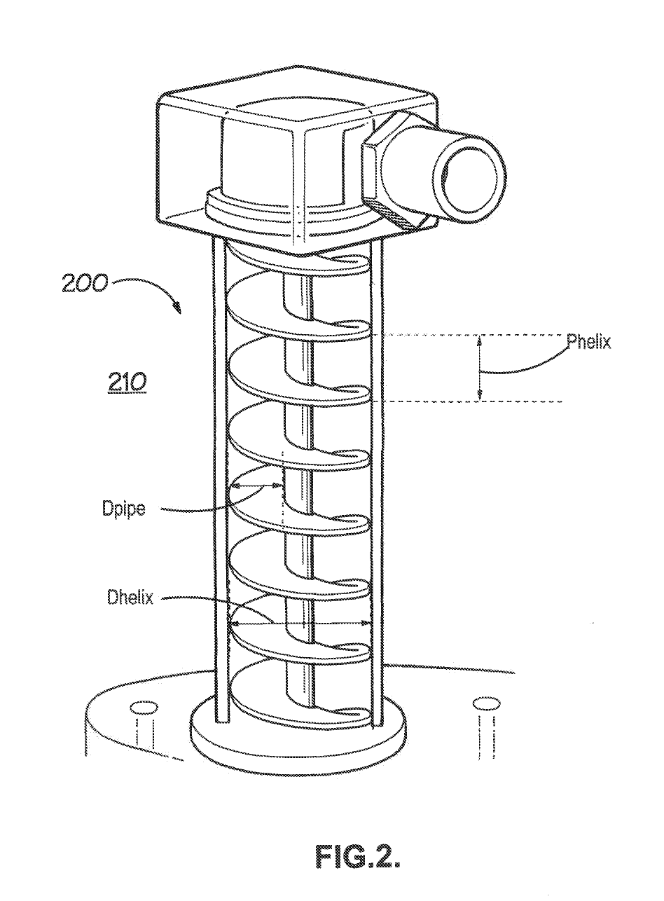

FIG. 2 is a part-transparent perspective view of a helical separator comprising a helical channel.

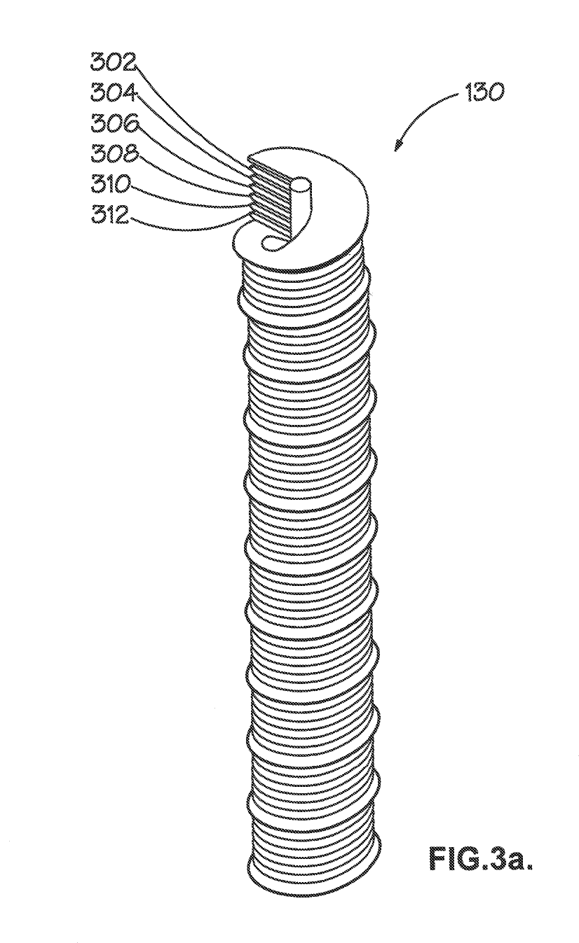

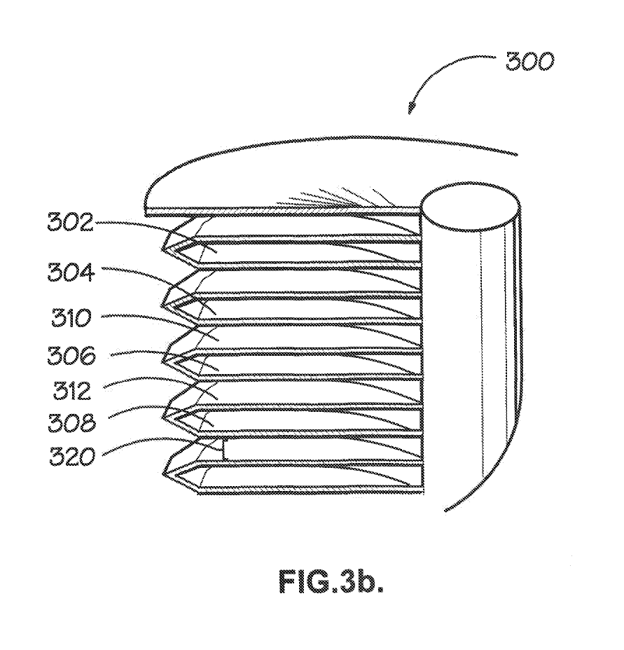

FIG. 3a is a perspective view of a helical air-plate heat exchanger for use as a condenser.

FIG. 3b is a part cut-away view of an end portion of the heat exchanger shown in FIG. 3a.

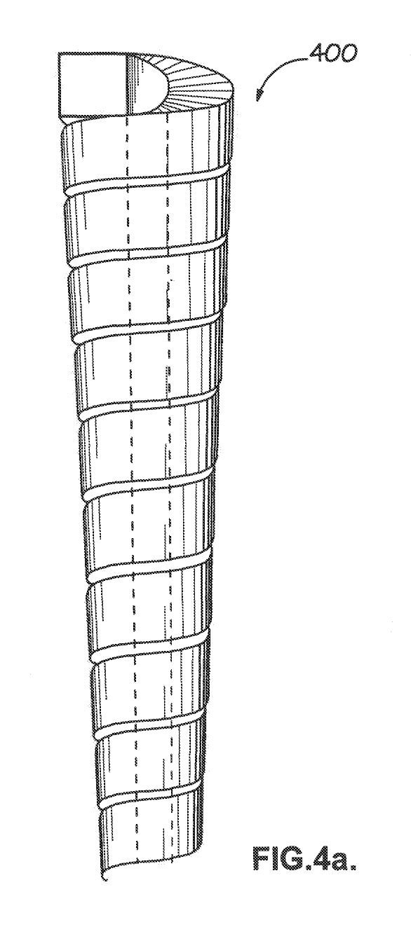

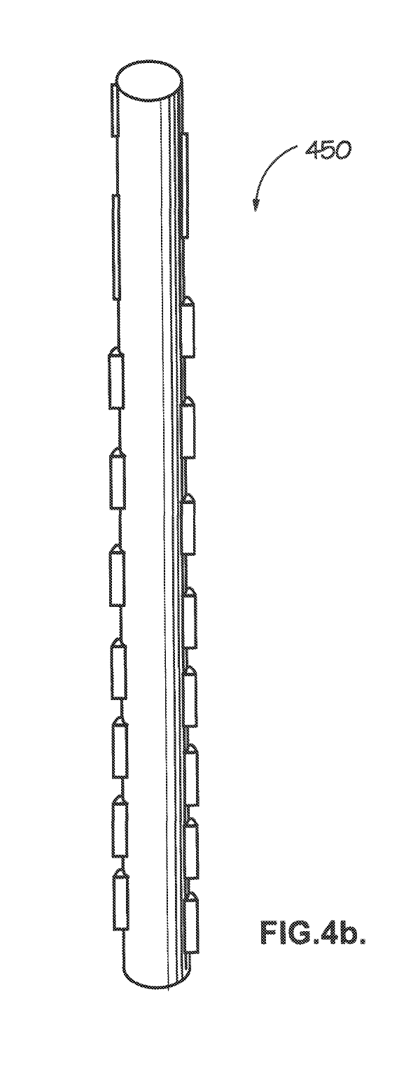

FIG. 4a is a perspective view of a tapered helical channel.

FIG. 4b is a perspective view of a vent and core structure arranged to be placed in the centre of the tapered helical channel of FIG. 4a.

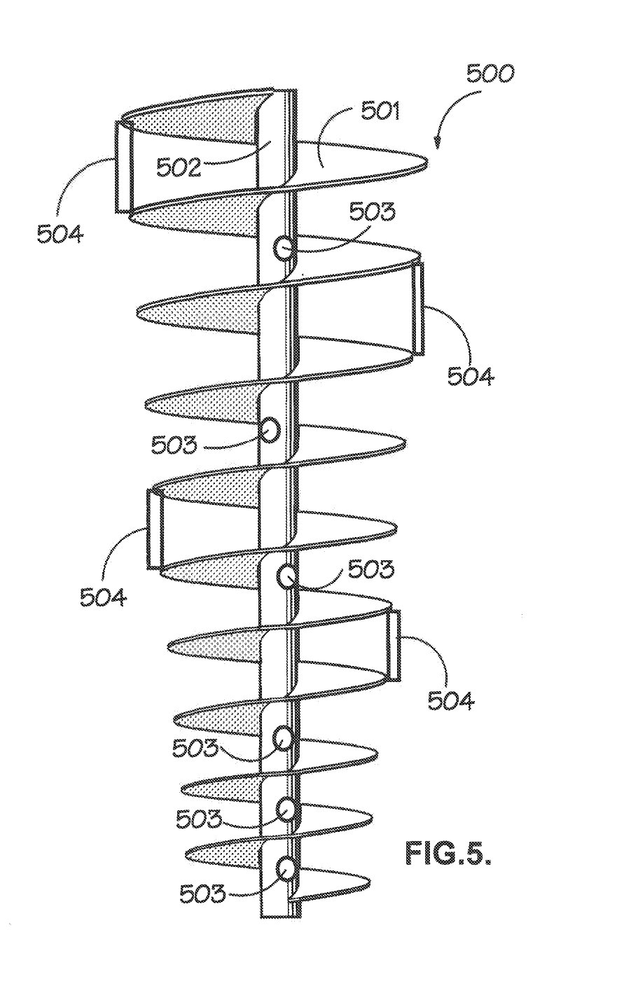

FIG. 5 is an internal perspective view of a tapered helical channel internal apparatus;

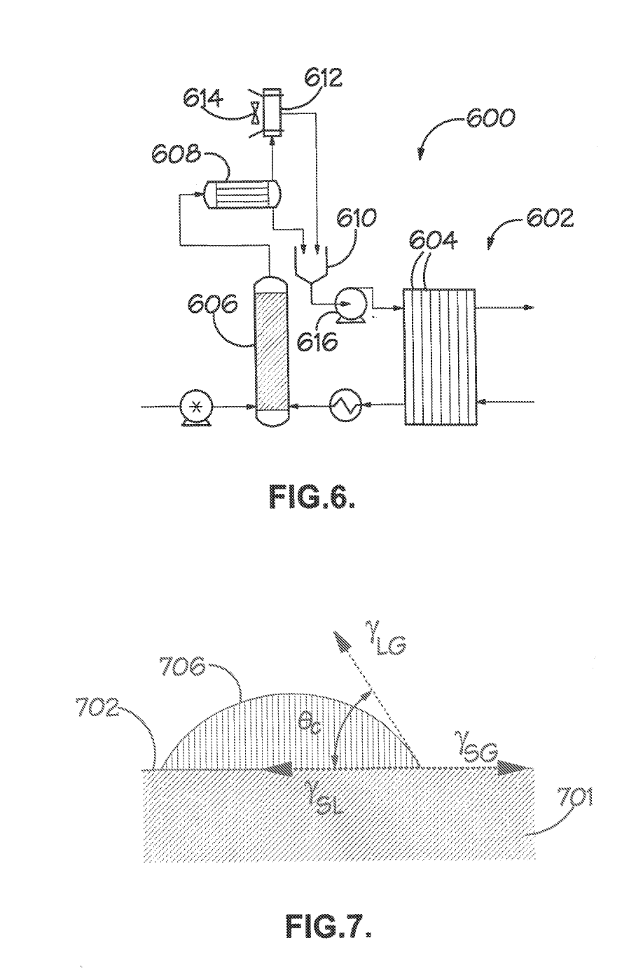

FIG. 6 shows a liquid electrolyte fuel cell system;

FIG. 7 shows a water droplet sitting on a low-energy solid surface;

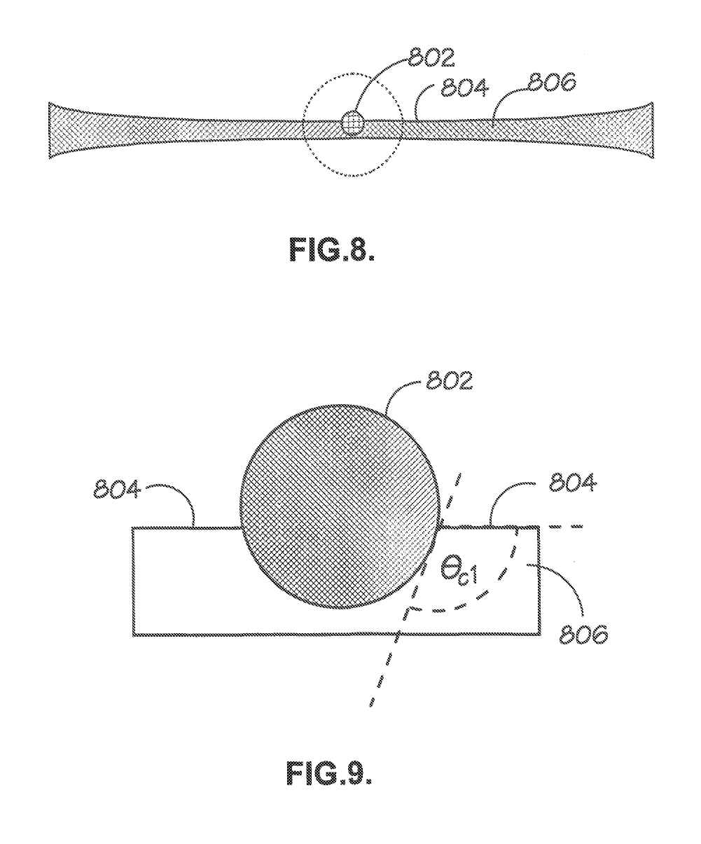

FIG. 8 shows a hydrophobic particle at a gas-liquid interface of an aqueous foam film;

FIG. 9 shows a zoomed-in view of the hydrophobic particle shown in FIG. 8;

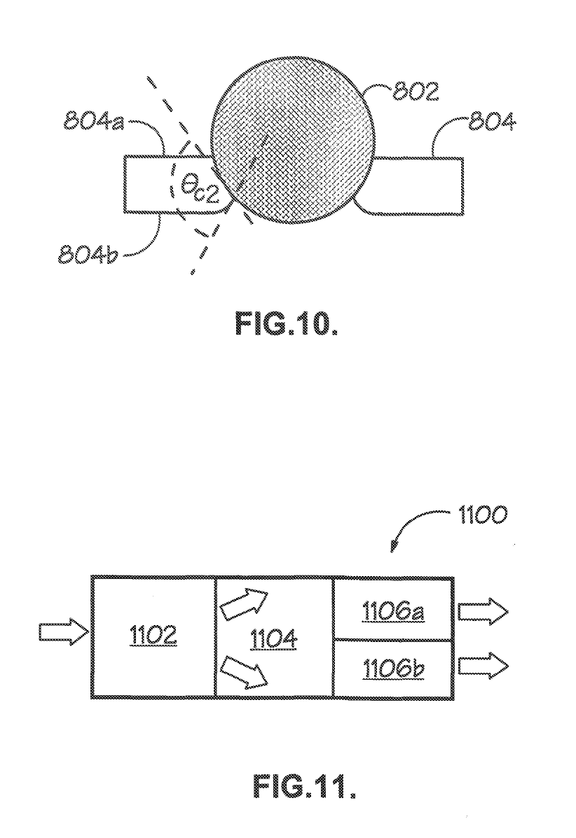

FIG. 10 shows the hydrophobic particle of FIG. 9 penetrating opposite surfaces of the liquid film of FIG. 9; and

FIG. 11 shows a fluid and gas conducting apparatus comprising a tubular section or vessel.

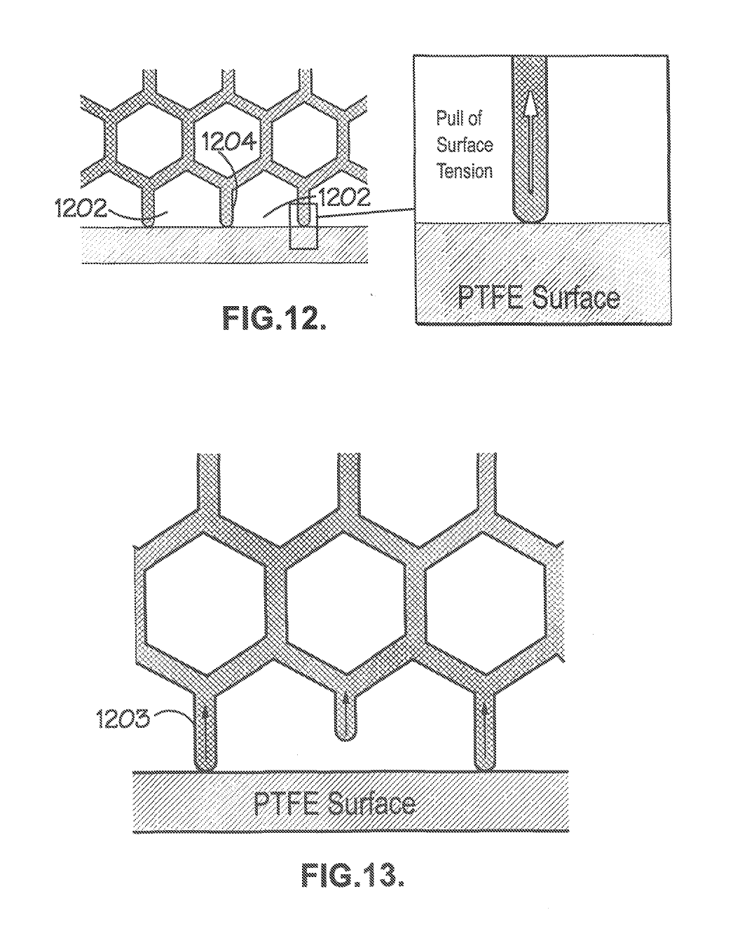

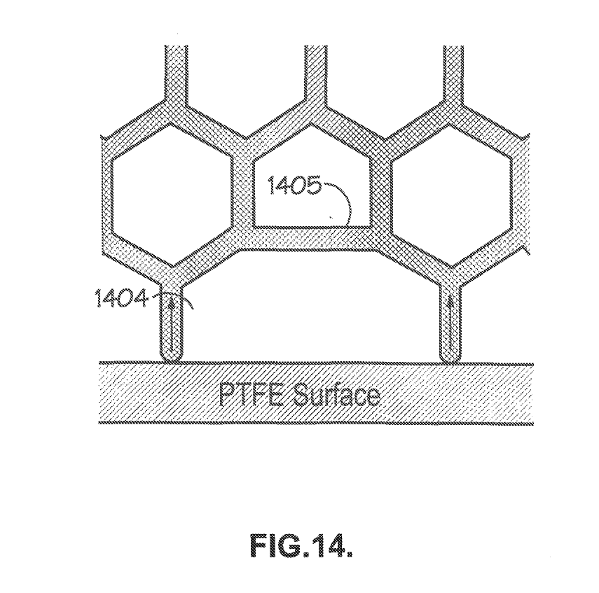

FIGS. 12, 13 and 14 are diagrams showing two small bubbles adjacent a low energy surface merging to form one larger bubble;

FIG. 15 shows a primary coalescer apparatus located within a pipe downstream from a gas-liquid contactor of a fuel cell system;

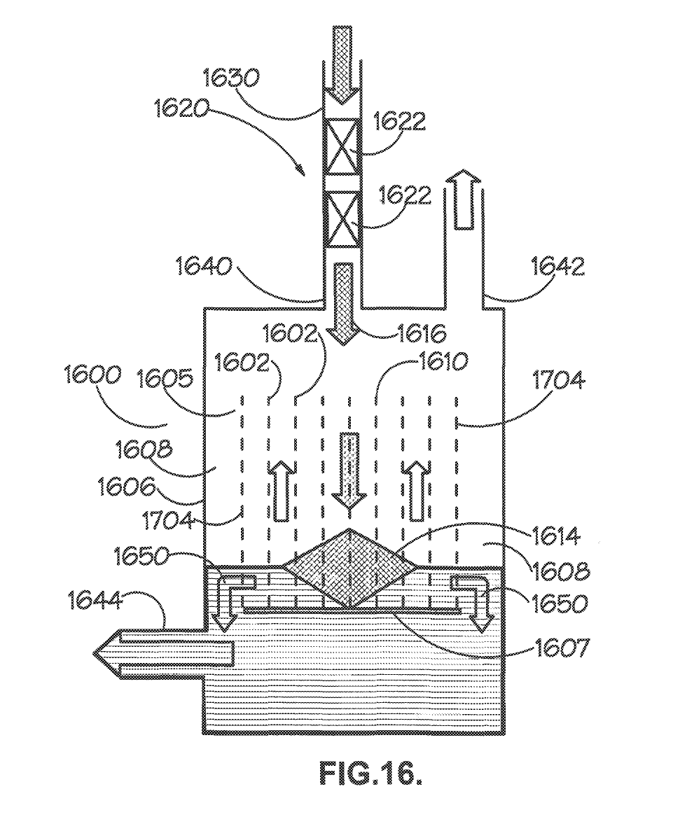

FIG. 16 shows a primary coalescer apparatus placed upstream of a secondary coalescer apparatus;

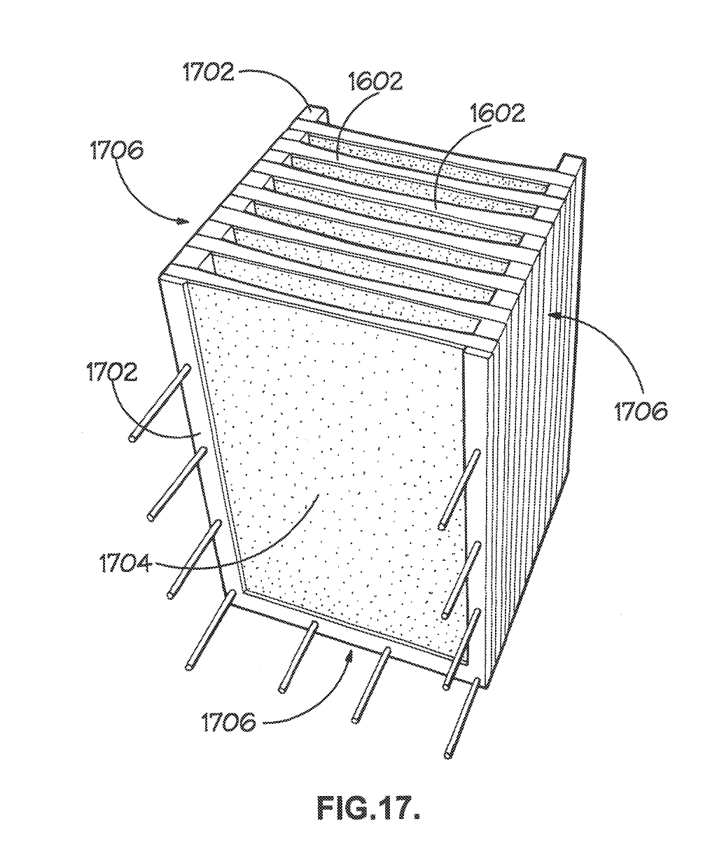

FIG. 17 shows a secondary coalescer apparatus in more detail;

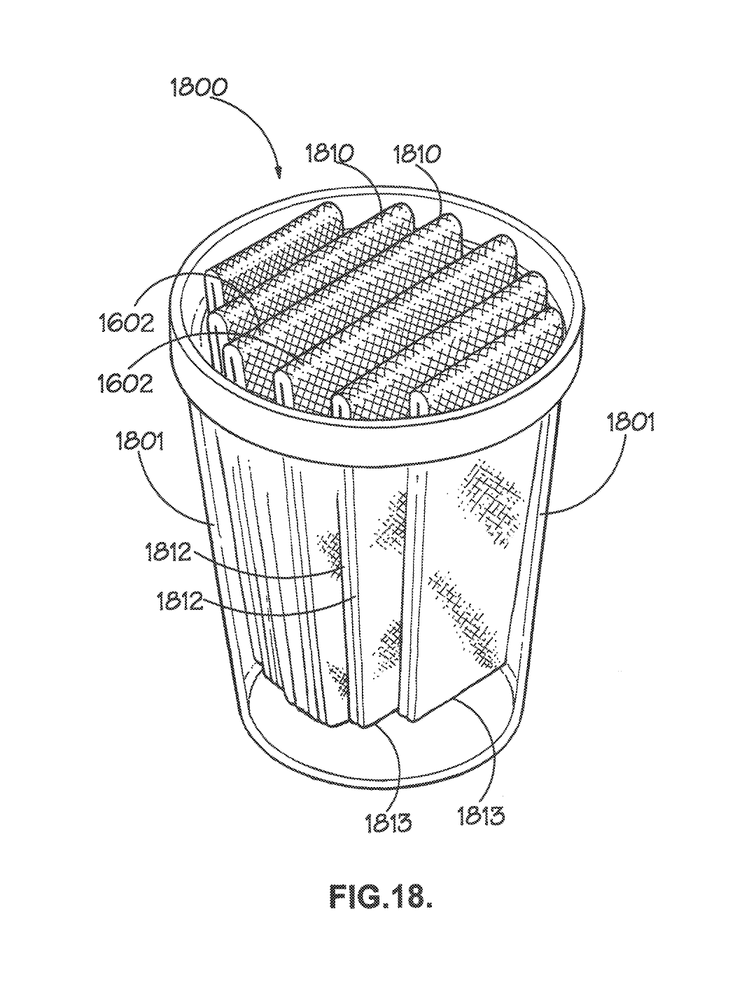

FIG. 18 shows a secondary coalescer apparatus different to that shown in FIG. 17;

FIG. 19 shows a primary coalescer apparatus located within a pipe downstream from a gas-liquid contactor of a fuel cell system;

FIG. 20 shows operation of a flow field existing beneath the fluid-plunging inlet of a secondary coalesce device; and

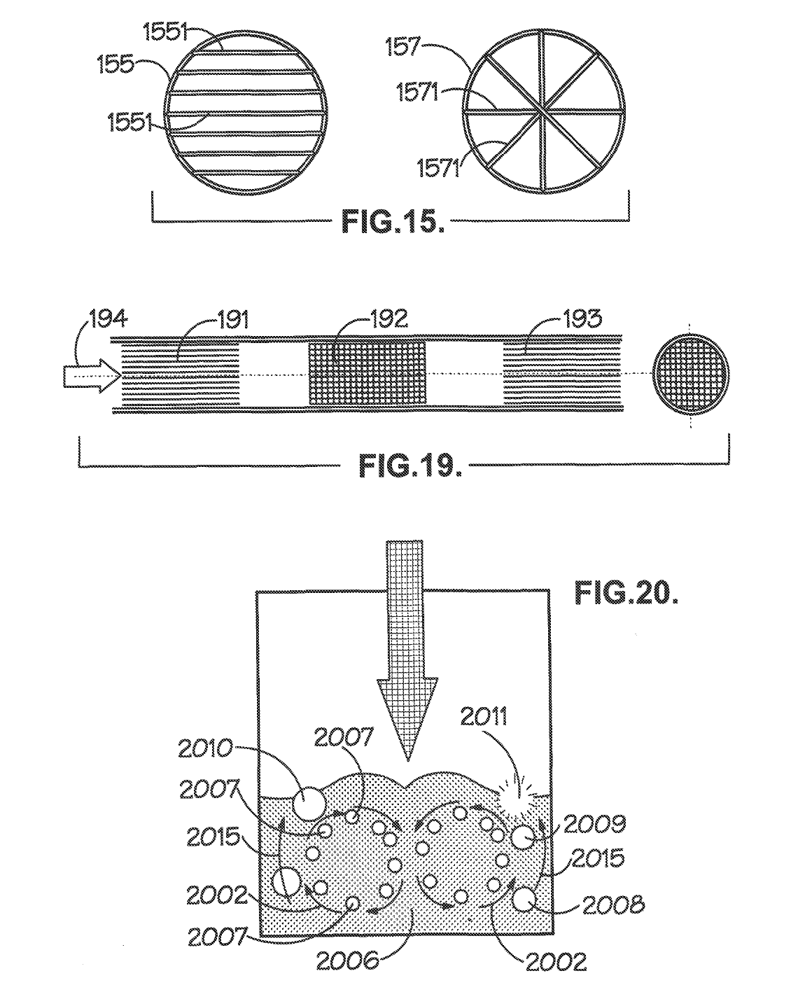

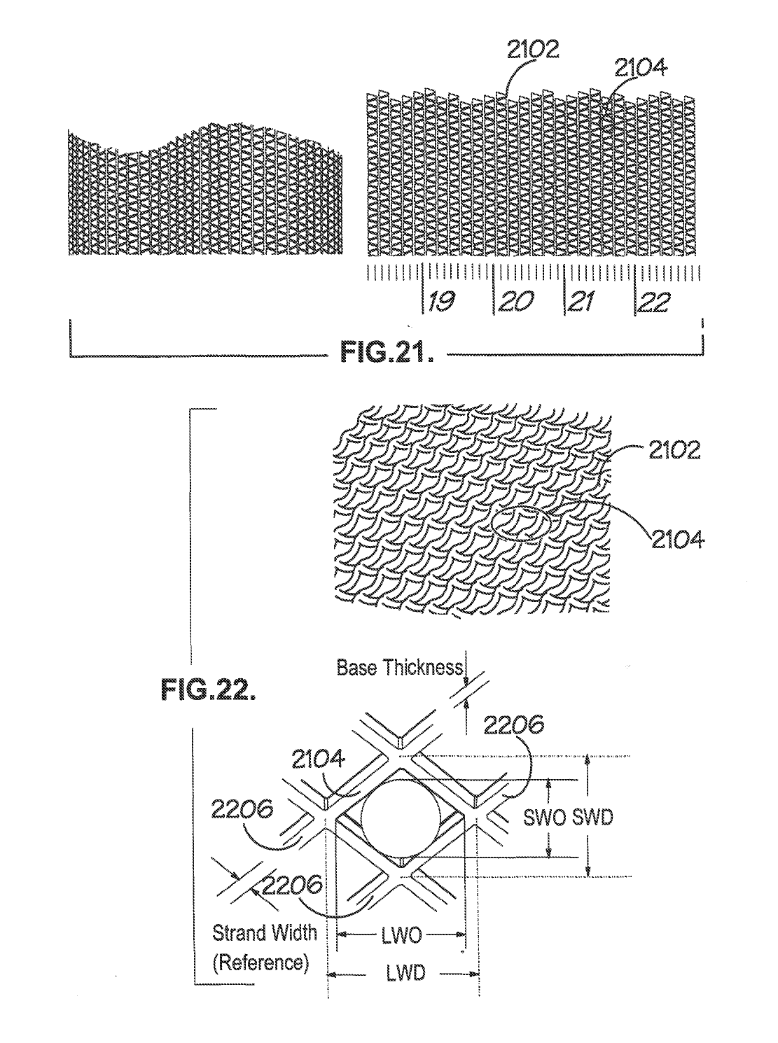

FIGS. 21 and 22 show detail of example mesh structures comprising surfaces having low surface energy.

The helical channel of the invention will now be described.

FIG. 1 is a simplified view of a helix 150 of a helical channel 100 for use in a liquid catalyst fuel cell to separate liquid and gas of a gas-liquid mixture. FIG. 1a is a side view of the helix 150 and FIG. 1 b is a perspective view of the helix 150.

The helix 150 has a helical axis 102 (z), a helical pitch 104 (P_{Helix}) and a diameter 106. Gas-liquid mixture is input to the channel at an input end 108 of the helical channel and is constrained to travel along the helical channel in the direction of the helix 150 towards an output end 110 of the helical channel 100.

It is worth noting that the image of the helix 150 shown in the figure represents the centre line of the helical channel and the dimension of P_{Helix} needs to take into account the thickness of a wall of the helical channel between adjacent helical flights in a longitudinal direction (parallel to the helical axis 102). That is, P_{Helix} should be measured from the top of one flight of the helical channel to the top of the adjacent flight above it, or from the bottom of one flight of the helical channel to the bottom of the adjacent flight below it. This can be more easily understood by referring briefly to FIG. 2 which will be described further below.

Clearly the helical channel has a hydraulic diameter i.e. a cross-sectional channel width or channel diameter (D_{Pipe}) at any one point along the helical channel as shown in FIG. 2. For example, if the channel is defined by a circular section pipe, the channel diameter is the diameter of the pipe (D_{Pipe}) whereas a square section pipe would have a channel diameter D_{Pipe} that is equivalent to the square section's hydraulic diameter.

Through the use of computational fluid dynamics, results have been obtained which indicate an optimal value of a dimensionless diameter ratio parameter (λ), this parameter being a ratio between the overall transverse-axial diameter or helical diameter (D_{Helix}) of the helical channel and the hydraulic diameter (D_{Pipe}) of a cross-section of the helical channel at any one point on the channel (λ=D_{Helix}/D_{Pipe}).

The optimal value of λ resulted in a maximal modified Dean number (Dm) for a chosen set of operational parameters, as will be explained below.

The Dean number (Dn) is a measure of secondary flow (inertial to centrifugal forces) and Dm takes into account appropriate helical geometrical factors.

By way of explanation, maximal separation should in theory occur at maximum Dm by virtue of the difference in the densities of each phase.

Modified Dean Number is given by:

Dm=Re√(κDₚᵢₚₑ/2)

where Curvature of the helix is given by:

κ=(D_{Helix}/2)/[(D_{Helix}/2)̂2+(P_{Helix}/2π)̂2]

where P_{Helix} is defined as the vertical distance from the bottom of the previous flight to the bottom of the next flight (i.e. D_{Pipe}+thickness of the helical flight), and Reynolds number (Re) for two phase flow given by

Re=(ρₘᵢₓVₘᵢₓDₚ)/μₘᵢₓ

where μₘᵢₓ (viscosity of the gas-liquid mixture) and ρₘᵢₓ (density of the gas-liquid mixture) are given by

μₘᵢₓ=εμ_{Gas}+(1−ε)μ_{Liq}

and

ρₘᵢₓ=ερ_{Gas}+(1−ε)ρ_{Liq}

respectively, where c is the gas volume fraction, ρₘᵢₓ is the density of the gas-liquid mixture, Vₘᵢₓ is the velocity of gas-liquid mixture, μₘᵢₓ is the viscosity of the gas-liquid mixture, and μ_{Gas}, μ_{Liq}, ρ_{Gas} and ρ_{Liq} are the viscosity and density of the gas and liquid, respectively. The gas volume fraction c is given by:

ε=Q_{Gas}/(Q_{Gas}+Q_{Liq})

where Q_{Gas} and Q_{Liq} are the flow rates of the gas and liquid respectively.

In turbulent flow, centrifugal forces are dominated by inertial forces and thus secondary effects are reduced. This accounts for the delayed development of turbulent flow in helical pipes (Mandal, S. N. & Das, S. K, Gas-Liquid Flow through Helical Coils in Vertical Orientation, Industrial & Engineering Chemistry Research 42, 3487-3494, 2003).

Initial modelling studies have been conducted by the inventors, in which P_{Helix} was fixed as 1.3 times greater than the channel or pipe diameter:

P_{Helix}=1.3*Dₚᵢₚₑ

It should be noted that manufacturing constraints (i.e. thickness of pipe wall)) limited this ratio. The free variables were thus flow rate and diameter ratio λ. Flow rates for the liquid and gas were constrained to practical operational values. That is to say, liquid flow rate (Q_{Liq}) was chosen to be between 3 and 30 Litres per minute (L/min) and gas flow rate (Q_{Gas}) was chosen to be between 12 and 120 Litres per minute (L/min). The diameter ratio λ was varied from 0 to 1000 with Dm as an output. The results of this study suggested an optimal value of λ occurs when a dimensionless pitch parameter (H) approaches unity, where

H=P_{Helix}/(2πR_{Helix}), where:

R_{Helix}D_{Helix}/2.

That is, the results suggested an optimal value of λ occurs when the helical pitch P_{Helix} is equal to π times the overall helical diameter D_{Helix}, i.e.

Optimum P_{Helix}=πD_{Helix}

This results in maximum modified Dean number being obtained.

Experiments were performed in which the variation of modified Dean number Dm was noted for different values of the dimensionless pitch parameter, H. It was found that Dm is maximum when H approaches unity, as suggested above. This corresponds to an optimal value of diameter ratio λ of 1/π, which is physically impossible.

From these results, values of Dm were calculated for different values of λ. The optimum value of λ provides a maximum value of Dm. Optimising λ for maximal Dm (in addition to optimising the dimensionless pitch parameter, H) provides a fully defined system.

As can be seen from the above, a consequence of the mathematical relations governing flow in a helical geometry means that the greatest Dm will occur in a pipe of given diameter when the helical diameter is smaller than the pipe diameter (optimum λ is 1/π). However, clearly, such a theoretical optimum value for λ is physically impossible, since the overall helical diameter D_{Helix} cannot be less than twice the pipe diameter D_{Pipe} (see for example FIG. 2 described below). This means that λ is constrained to be greater than or equal to two. In practice, λ must be greater than two because of non-zero wall thickness of the helical channel.

Therefore the best physically-realisable value of λ is slightly greater than two, that is, as close to two as possible, to achieve maximum value of Dm.

Preferably therefore, according to a preferred embodiment, D_{Helix} and D_{Pipe} at any one point are arranged such that the overall helical channel diameter D_{Helix} is as close to 2*D_{Pipe} as physically achievable.

FIG. 2 is a part-transparent perspective view of a helical separator comprising a helical channel that has been used successfully to separate electrolyte liquid and gas (air) at full scale flows. The resulting pressure drop in this configuration is less than 12.5% of the pressure drop that occurs in a known GLCC design of similar size, thus performing bulk separation of the liquid and gas.

After bulk separation is performed by the apparatus of FIG. 2, some mist droplets are seen in the air flow in the output region. Also, it is known that the air exiting the separator is saturated with vapour phase liquid.

Even though the separator of FIG. 2 is effective at separating gas and liquid, a relatively large proportion of liquid becomes trapped in its vapour phase even upon separation of the gas and liquid phases. This is due to the operating conditions of the FlowCath™ system, i.e. the operating conditions of gas-liquid contacting and the relatively high temperature at which this gas-liquid contacting operation is carried out. This represents a potential application of this technology for a heat transfer application (see FIGS. 3a, 3b, discussed below).

Separation of vapour phase liquid from gas can be performed by known air-air heat exchanger technology. However, although air-air heat exchangers are relatively efficient at the industrial scale, they do not condense enough liquid from the vapour phase to control concentration in at least one known 1 kW net steady state system with the existing size and power constraints of the FlowCath™ System. This limitation represents a problem to solve.

Two methods of achieving better vapour phase removal of liquid are: (a) increasing surface area of the heat exchanger; and (b) increasing cold air flow through the heat exchanger. However these methods are non-optimum because of large packaging volume and large parasitic load, respectively. A problem therefore still exists.

In attempting to address the above problems and limitations, it has been found that a second spiral separator (of the same dimensions of the first) can be very effective in removing any entrained liquid phase droplets, giving exceptionally good separation of electrolyte and also some preliminary condensation of water.

Additionally, in a preferred envisaged configuration of a helical separator, a cold-air stream and a hot-air stream (water rich in the vapour phase) are segregated by a metal (e.g. steel) enclosure in a helical flow path.

A first helical channel (e.g. the helical channel 200 of FIG. 2) separates the liquid and gas of the gas-liquid mixture to produce (a) bulk liquid that is still in the liquid phase, (b) a gas phase saturated with vapour phase liquid and (c) a liquid phase that is entrained in the gas phase in the form of mist. A second helical channel (e.g. the helical channel 302 of FIG. 3a or 302 of FIG. 3b discussed below) then separates the saturated gas phase and liquid phase droplets into gas and liquid phase liquid.

Secondary flow within the curved geometry of a helical channel increases heat transfer coefficients, the effect of which is greater for laminar flow. The flow regime for the current FlowCath™ system (and those in the near future) will be laminar for an air-plate condenser. It has been found that confining a plate or fin of a heat exchanger within, or as part of, an enclosed helical channel serves to enhance separation of vapour phase liquid and gas as a result of the (approximately two-fold) increase in heat transfer coefficient. This allows the surface area of a condenser to be halved whilst still affecting the same amount of separation.

It follows that an aspect of the invention is providing a separator for a liquid electrolyte regenerator of a fuel cell system comprising a helical channel in the form of a pipe formed on a helix and arranged to conduct a gas-liquid mixture and separate liquid from the gas-liquid mixture, wherein the helical channel of the separator is an enclosed channel along which the gas-liquid mixture is constrained to travel. The helical channel can be used as a heat exchanger (for example, an air-air plate condenser or counter current shell and tube exchanger for denser fluids) for conducting a fluid to be cooled. Such a heat exchanger is particularly useful for conducting and cooling fluid in vapour phase so as to perform condensing of the fluid.

FIG. 3a is a perspective view of a proposed configuration of a new helical air-plate heat exchanger 300 employing this principle for use as a condenser. The heat exchanger 300 comprises six enclosed helical channels 302, 304, 306, 308, 310, 312 (five channels for the cooling air and the remaining channel to be used for the hot, vapour rich air.)

FIG. 3b is a part cut-away view of an end portion of the heat exchanger 300 shown in FIG. 3a. Helical channels 302, 304, etc. can be seen more clearly. Between adjacent (cold-air) helical channels, a gap 320 exists, in which fluid such as hot, vapour rich air can move past the outer surface 310, 312 of each helical channel. As can be seen, the helical channels in this embodiment are in the form of hollow fins. In this case the ‘helical channel’ comprises plural hollow fins. The hollow construction allows separate supply of cooling fluid (e.g. air) which will flow over the outer surface of the helical channel but will not mix with the gas-liquid mixture within the helical channel.

A currently employed, off-the-shelf air-air plate condenser has approximately 0.8 m² total surface area (UK Heat Exchangers™). By contrast, the heat exchanger shown in FIGS. 3a and 3b has a total cold surface area of 0.431 m², made possible by the two-fold increase in heat transfer coefficient, which allows a significant reduction in overall size of a condenser used in a given PEM fuel cell system.

Further improvement of the heat exchanger may be achieved by increasing the surface area of the fins or cooling surfaces of the helical channel of the heat exchanger, by providing non-smooth cooling surfaces, for example by means of corrugation and/or dimpling of the cooling surfaces (FIG. 3b, 310, 312), without any need for increased packaging volume.

A further improvement in separation may be achieved by arranging the fins or cooling surfaces so that they comprise a surface comprising a low surface energy material (for example PTFE). A highly hydrophobic material can induce coalescence by harnessing the de-wetting force to force plateau borders apart, thereby becoming energetically favourable to form a single bubble, rather than two bubbles separated by a plateau border.

According to an embodiment, there is provided a combination of the helices shown respectively in FIGS. 2 and 3 with the exception that the closed section shown in FIG. 3b is left open. In this embodiment, the gas-liquid mixture enters the helix as described above for FIG. 2. However, the fluid passage houses several “fins” with flights running parallel to the main helix flight. These fins, the wall of the helix tube and the main helix flights would be coated with a low surface energy material. The diameter of the fins would be slightly less than the main helix diameter to allow the development of helical flow as described above for the embodiment shown in FIG. 2.

The above-described low surface energy fins would not affect the overall fluid flow within the helix greatly, although there would be additional pressure drop per unit length due to an increased internal surface area/friction effect. However, it is likely that there would not be an overall increase in pressure drop as these low surface energy fins would increase the rate at which gas-liquid separation is effected and therefore would require a shorter overall length of helix. This embodiment allows the overall size of the device to be reduced whilst maintaining effective separation.

FIG. 4a is a perspective view of the fluid passage of a tapered helical channel 400 having a greater helical diameter at the inlet and a smaller helical diameter at the exit. The gas-liquid mixture enters at the inlet. The separated gas then exits gradually through gas vents in an inner core of the helix (FIG. 4b) with a minimal amount of air exiting through the fluid exit, thus approaching pipe flow and moving away from free surface flow. The venting of air partway down a helix has been proposed by Rosa et al (Rosa, E, Journal of Petroleum Science and Engineering 32, 87-101, 2001, and OAPI patent application publication no. OA11321 (A)). However, Rosa discloses an arrangement having a constant helix diameter unlike the embodiments described above and shown in FIGS. 4 and 5 which have a graduated helical diameter and a graduated pipe diameter.

The embodiment shown in FIGS. 4a and 4b provides an improvement over the design shown in FIG. 2. Using a pipe that decreases in diameter as the fluid travels downward towards the outlet will result in an increase in velocity according to the continuity equation. Concomitantly, the effective gravity force acting on the gas-liquid mixture will increase.

Even in the case of a high gas to liquid ratio the difference in densities is very large such that the contribution of the gas to the momentum of the gas-liquid mixture is minor. Thus, even when complete separation is achieved, the fluid maintains the majority of the momentum it had when entering the helix as a gas-liquid mixture. The decrease in pipe diameter as the fluid travels towards the outlet is such that the liquid will increase in velocity. As a result of the increase in fluid velocity and the decrease in radius of rotation the effective gravity acting on the gas-liquid mixture increases dramatically compared to a constant-section helical separator.

For example, using the same flow rate and composition of gas-liquid mixture the effective gravity imposed on the constant section (FIG. 2) is 10 g (i.e. 10 times gravity, that is, 98.1 m/s²), whereas the effective gravity imposed on the tapered helix shown in FIG. 3a and FIG. 3b starts at 10 g and reaches a much higher maximum of 21 g.

FIG. 5 is an internal perspective view of an internal apparatus 500 that may be used to define the tapered helical channel 400 shown in FIG. 4a. The internal apparatus 500 has a spiral vane 501 and an inner wall 502, attached to the vane 501, which may have one or more gas vents 503 in it, allowing gas to exit vertically or part-vertically so as to prevent re-entrainment upon fluid exit. This configuration serves to abrogate pulsating flows which can be caused by “slugs” of liquid-rich material forming in the channel. It also serves to reduce the overall size of the channel, to move away from free surface flow and, most importantly, to increase separation efficiency. The helical channel 400 (FIG. 4a) comprises an outer wall (not shown) adjacent to and surrounding the spiral vane 501 of the apparatus 500.

The gas vents 503 may comprise a microporous membrane 503, which may form all or part of the inner wall 502 of the helical channel 400, allowing gas to escape early and preventing liquid escape due to the hydrophobic nature of the membrane. The gas vents 503 are arranged to inhibit the passing of liquid through them due at least in part to their small diameter.

The helical channel 400 (FIG. 4a) may comprise a porous bubble generating element 504 (not shown in FIG. 4a) incorporated in the outer wall of the helical channel 400. The positioning of the porous bubble generating element 504 utilises the already existing differential density between gas and liquid in addition to the imposed centrifugal gravity as a result of the helical flow path in the helical channel 400 to ensure rapid movement of gas from outer wall to inner wall 502. This arrangement allows the greatest mass transfer rate (which corresponds to reaction rate in this system) between the gas and liquid as a result of the greatest driving force for mass transfer and reaction (high concentration of reactants).

Additionally, this arrangement allows an overall very high gas-liquid ratio to be achieved which would not be possible by using a single air injection point.

The porous bubble-generating element 504 may be used to concurrently perform gas-liquid contacting, whilst the turn (flight) of the helix after the porous element can be used for separation. The porous element 504 is shown in FIG. 5 as plural openings or vents, but could equally be a microporous membrane. The porous element 504 allows the helical channel to operate both as a separator and as a regenerator. It should be understood that the gas vent 503 and porous element 504 can be used with a helical channel having a helical diameter that is not tapered or graduated, i.e. is constant.

The use of the porous element or aperture(s) may enable more volumetric efficient helix geometry because of the dual function of gas-liquid contacting and gas-liquid separation.

Helical flow devices are widely used in heat transfer applications. However, helical flow has not been used in a liquid catalyst fuel cell system. Such liquid catalyst fuel cell systems have not included any capability for the destruction of foams or separation of droplet streams having high gas-liquid ratio. The use of a microporous membrane to vent air/gas from a helical channel to achieve separation of a gas-liquid mixture is novel.

FIG. 6 shows a liquid electrolyte fuel cell system 600. In this system, liquid redox cathode electrolyte (catholyte) is circulated through a fuel cell stack 602 in which it is reduced due to the action of the fuel cells 604 in the fuel cell stack 602. The liquid redox catholyte is then passed through a regenerator 606, in which the catholyte is oxidised.

The oxidisation process requires the contacting of liquid catholyte with large volumes of air, the liquid and air being in a ratio greater than 4:1 air-to-liquid on a volume basis at standard temperature and pressure (STP) and ideally up to 20:1 or greater. Interfaces between the liquid and gas/air are generated in the form of bubble membranes or films. It is desirable to maximise the total area of these gas-liquid interfaces in order to maximise mass transfer of oxygen from the gas/air into the catholyte.

The gas-liquid interface in the regenerator is in the form of high internal phase volume foam comprising bubbles having small bubble radius. The rate of regeneration (oxidation) of the liquid catholyte is proportional to the total interfacial area of the gas-liquid interface. High rates of regeneration are required so that the fuel cell stack can generate a useful amount of power for a typical use of the fuel cell system 600.

The regenerated electrolyte and gas, mixed with the electrolyte, are then conducted together into a gas-liquid separator 608 comprising the helical separator (FIG. 2, 200). The separator 608 provides as outputs (a) bulk liquid electrolyte and (b) a less dense gas-liquid mixture comprising gas (air) mixed with liquid electrolyte in the form of droplets/mist and/or vapour-phase liquid. The more dense liquid is fed (in this example by gravity) to a reservoir 610 for collecting the liquid in the mixture in the form of bulk liquid in liquid phase. The separator outputs gas which is conducted into a condenser 612, in this example the condenser shown in FIGS. 3a and 3b (FIGS. 3a and 3b, 300).

External cooling air is passed across cooling fins of the condenser 612 by means of a cooling fan 614. A fluid pump 616 pumps liquid collected by the reservoir 610 and outputs the liquid to the fuel cell stack 602 for use as electrolyte in the fuel cells 604 of the fuel cell stack 602. The condenser 612 outputs condensed liquid (condensate) to the reservoir 610 in the form of liquid-phase liquid.

Turning again to the regenerator 606, once the liquid electrolyte (catholyte) has been regenerated, the residual gases (mainly Nitrogen) must be removed from the catholyte which is supplied to the cathodes of respective fuel cells 604 and should not contain gas bubbles because such bubbles would interfere with the operation of the fuel cell 604. It is highly desirable that disengaging or separating the residual or “spent” gases is performed rapidly, efficiently and with minimal power consumption.

Mechanical separation methods such as hydro-cyclones and centrifuges use an unacceptable amount of power. The helical separator 608 can provide an alternative mechanical separation which requires lower power. However, there is an ever present requirement to improve separation efficiency at reduced power and in a smaller physical volume. Therefore it is desirable to employ a method of separation other than, or additional to, the mechanical separation methods so far described above.

International patent application publication WO 2010/108227 discloses a method and apparatus for dry separation of hydrophobic particles. However WO 2010/108227 is directed to particle separation, and not gas-liquid interface disruption, and does not relate to fuel cells. German patent publication DE10323155A1 discloses a separator for the removal of liquid in droplet or aerosol form from a gas stream. However DE10323155A1 is not concerned with foam or a fuel cell.

Japanese patent publication JP3038231, incorporated herein by reference, discloses a separation unit membrane composed of hydrophilic parts and hydrophobic parts. Japanese patent publication JP1297122, incorporated herein by reference, discloses a material consisting of a thin film of liquid containing a carrier held in a laminated form with a film composed of only hydrophobic pores used as a liquid film for gas separation.

Separation of liquid and gas in foams has been previously investigated. For example, see “Defoaming: Theory and Industrial Applications”, P. R. Garrett, CRC Press, ISBN 0-8247-8770-6, incorporated herein by reference. See also “The Physics of Foams” D. Weaire & S. Hutzler, Clarendon Press, ISBN 0-19-851097-7, pages 149-150, incorporated herein by reference. There is also “The effect of high volume fraction of latex particles on foaming and antifoam action in surfactant solutions”, P. R. Garrett, S. P. Wicks, E. Fowler, Colloids and Surfaces A: Physicochem. Eng. Aspects 282-283 (2006) 307-328, incorporated herein by reference.

The action of so-called ‘antifoam’ in the disruption of liquid films and bubbles is well known. There exist various mechanisms by which antifoam can disrupt the gas-liquid interface of foam, the mechanisms depending on the formulation and form of the antifoam, but such mechanisms can generally be described by the following explanation of the interaction between a liquid film and a low surface energy surface. This action results in so-called ‘de-wetting’. De-wetting describes the rupture of a thin liquid film on a substrate (either a liquid or a solid) and the formation of droplets. The opposite process (spreading of a liquid on a substrate) is called ‘spreading’.

FIG. 7 shows a solid object 701 which has a surface 702 having low surface energy. A water droplet 706 sits on the low-energy surface 702. The droplet will rest in a position such that a defined contact angle, denoted by θ_{c} in the figure, is subtended between the low-energy surface and the surface of the droplet in contact with the surrounding gas/air.

The angle is defined by Young's equation, as set out below:

γ_{SL}+γ_{LG} cos(θ_{c})=γ_{SG}

FIG. 8 shows a low surface energy, hydrophobic, particle 802 at a gas-liquid interface 804 of an aqueous foam film 806.

FIG. 9 shows a zoomed-in view of the hydrophobic particle 802 and gas-liquid interface 804 shown in FIG. 8. The particle will rest in a position in or on the film 806 so that a defined contact angle between the film surface and the iii particle surface will satisfy Young's equation given above, the angle being denoted by θ_{c1} in FIG. 9.

FIG. 10 shows the hydrophobic particle 802 of FIG. 9 penetrating opposite surfaces 804a, 804b of the liquid film of FIG. 9. The opposite surfaces of the liquid film 806 provide two respective gas-liquid interfaces 804a, 804b. When the particle penetrates the film 806 as shown, the particle protrudes from each opposite surface 804a, 804b of the film 806, and a contact angle is defined at both gas-liquid interfaces, the angle being between the (tangential) surface of the particle and the surface 804a, 804b of the film, the angle being denoted by θ_{c2} for the lower gas-liquid interface 804b in FIG. 10, the angle θ_{c1} not being shown in FIG. 10 for ease of reading. As the particle penetrates the film 806, the liquid film 806 is ruptured and the bubble bursts thereby achieving the de-wetting effect outlined above. The hydrophobic, or antifoam, particle then moves (for example, due to gravitational force) to the next gas-liquid interface which is provided by a membrane wall or film of an adjacent bubble, and so on.

As can be deduced from the above, introduction of an antifoam agent in the form of hydrophobic particles into a gas-liquid foam is effective in separating gas and liquid in the foam and thereby converting the foam into separate liquid and gas portions.

However, in the liquid catalyst fuel cell system, presence of antifoam particles in the liquid electrolyte could adversely affect operation of the fuel cells. Also it would be disadvantageous if such an anti-foam agent were present in liquid catholyte entering the regenerator because the regenerator generates a gas-liquid interface by means of bubbles to promote oxidation and an antifoam agent in the liquid electrolyte would inhibit such bubble generation. It can be seen that there exist two conflicting requirements: for generation of foam it is best if no anti-foam agent is present; whereas anti-foam agent is effective in the destruction of foam. In the liquid electrolyte fuel cell system, both generation of foam and destruction of foam are required.

Embodiments provide an inventive way to avoid this conflict and seek to provide a further-improved helical separator arranged to separate gas and liquid with further improved efficiency. According to these embodiments the helical channel of the helical separator (e.g. the separator shown in FIG. 2 (FIG. 2, 200) comprises a surface comprising a low surface energy material and arranged to contact the gas-liquid mixture.

It should now be appreciated that it is possible to cause foam disruption/destruction by contacting the foam with one or more hydrophobic surfaces. Such a surface is not merely hydrophobic particles, but is a surface of a solid structure that comes into contact with the gas-liquid mixture comprised of foam or bubbles, thereby causing gas-liquid interfaces to be ruptured.

Low energy surfaces are found in certain polymers, for example polytetrafluoroethylene (PTFE) which has a surface energy of around 18 mJ/m². Surfaces of such polymers have been used very effectively to break down foams.

According to embodiments, electrolyte foam and low surface-energy material can be moved adjacent to each other (one and/or the other moving). The foam can simply pass along a plane or curved surface of the low surface-energy material or the low surface-energy material can be in the form of a mesh and the mesh and foam can move relative and adjacent to one another.

For example the foam can be forced through a holed member, for example a mesh, comprising low surface-energy material. Alternatively the holed member can be forced through the foam. The use of a holed member or mesh increases the specific surface area of disruptive interface. The hole size can vary from 0.1 millimetre to 10 millimetres, and the holed member can comprise a mesh having filaments of low surface-energy material (e.g. polymer) having diameters between 50 micrometres and 1 millimetre.

As the foam and holed member pass next to each other, the gas-liquid interface of the foam is ruptured and the gas and liquid separate into a denser liquid phase and a less dense gaseous phase. This operation, when performed prior to further mechanical separation (the further mechanical separation being performed by a further helical separator for example) enhances the overall separation. Such a further helical separator may be a condenser as exemplified by the condenser (FIG. 6, 612).

Including a holed member e.g. mesh either up-stream or down-stream of the helical separator within the liquid electrolyte fuel cell system enhances the separation of the gas and liquid phases.

Alternatively or in addition, low surface energy materials can be incorporated within the helical separator, internal surfaces of the separator comprising low surface energy material, as described above in relation to the helical separators of FIGS. 2, 3 and 4. Optionally and advantageously, a holed member or mesh can be present inside the helical channel of such a helical separator.

Further advantage can be obtained when the helical separator comprises an internal surface having a rough finish. Preferably the internal surface also has a low surface energy, for example it comprise a coating of low-surface energy material. Preferably the roughness of such a rough finish has a dimension (e.g. average dimension) that is of the same order as the average film thickness of the liquid foam. For example the internal surface may have raised portions (bumps or ridges) that have a width which is similar to the average thickness of the film of the foam.

This approach of using a surface having low-surface energy can also be applied to other gas-liquid separation functions, such as the separation of hydrolysis gases from the electrolyte liquid of the liquid electrolyte fuel cell system.

According to an embodiment, the foam is conducted from the gas-liquid contacting section of the regenerator through conducting apparatus comprising three sections:
a feed section for distribution of foam across a mesh section
low surface energy mesh packing section for separation
a phase separation section with two outlets, one for gas the other from liquid

FIG. 11 shows a conducting apparatus 1100 comprising a tubular section or vessel 1100 which contains such a feed section 1102, mesh packing section 1104 and phase separation section 1106 comprising gas section 1106a and liquid section 1106b. Gas is output from the gas section 1106a and liquid is output from the liquid section 1106b. The flow of fluid through the apparatus 1100 is indicated by arrows.

As an example of the use of mesh to perform separation of gas and liquid in a foam, liquid electrolyte, 10 ml volume, was placed in a measuring cylinder and air was passed through the catholyte with a flow rate of 0.5 litre/minute using a sintered glass sparge. The foam thus-formed over-filled the measuring cylinder. A PTFE knitted mesh was placed in the throat of the measuring cylinder and air was sparged again using the same conditions. The effect of this was to efficiently rupture the foam and separate the gas and liquid phases.

There will now be described further aspects and embodiments of the invention relating to recent investigations and experiments by the inventors concerning the use of LEM-assisted froth disruption.

A general principle of froth disruption (destruction or breakdown of froth or foam) using Low Energy Material (LEM), typically comprising a mesh will first be explained, as follows.

Effective gas-liquid separation, when used as part of a fuel cell system, acts to prevent:
i) gas carry-under to the liquid electrolyte (catholyte) pumps and the fuel cell stack and,
ii) liquid carry-over to the gas exhaust (output) of the stack.

In order to minimise both parasitic load (power consumed by the gas-liquid separation reactor) and gas-liquid separation reactor size, this operation must be accomplished with optimum energy and volume efficiency (i.e. using a small gas-liquid separation reactor which consumes little power). Investigations by the applicant have that PTFE meshes effective in collapsing V4 POM froth or foam. PTFE is a low surface energy material (LEM) and is therefore highly hydrophobic and thus water repelling (having surface energy of around 18 mJ/m2 at 20° C.).

If exposed to an aqueous frothy mixture, the low surface energy material selectively repels the liquid phase. This has the effect of thinning the liquid boundary between bubbles of the foam (the liquid bubble-to-bubble boundary) at the point of contact of the bubbles with the LEM surface, promoting rupture and thereby coalescence of the bubbles i.e. merging or agglomerating of small bubbles into fewer larger bubbles. In the merging process a plurality of bubbles merges or coalesces to form one single bubble, this occurring for multiple groups of bubbles. FIGS. 12 to 14 show two small bubbles 1202 merging to form one larger bubble 1404. The membrane portion 1204 joining the two smaller bubbles 1202 retracts away from the LEM surface 1201 resulting in a single membrane portion 1405 or wall section which defines part of the boundary of the larger bubble 1404. Presenting the low surface energy surface as a plurality of fine strands, typically as a mesh has the following advantages:

i) it provides an open, optionally immobile, structure which encourages bubble contact with the surface and encourages release of bubbles from the surface, and
ii) it encourages the coalescence of small bubbles by taking advantage of the ‘contact geometry’. Other LEMs are available but PTFE has been found to be very suitable for this application.

FIGS. 12, 13 and 14 thus together show such a mechanism of LEM-based, or LEM-assisted, bubble coalescence. As suggested above, the process can be enhanced by the contact geometry, i.e. the geometry of the active surface which interfaces with the bubbles. Curving the LEM surface, as is achieved by a circular cross section of a mesh strand for example, allows a low angle of contact between the bubble's membrane and the surface, which acts to undermine even further the liquid bubble-to-bubble boundary, thus further weakening attachment of the bubbles to the low-energy surface.

The concept of separation by LEM-assisted bubble coalescence and gas-liquid phase segregation will now be described in more detail.

Gas-liquid separation involving LEM materials can be regarded as a two-stage process. As explained above, LEM materials accelerate or promote froth collapse by enhanced or increased bubble coalescence or merging, effectively causing bubble collapse. However, this process alone does not separate gas from liquid; it merely transforms a fine 2-phase flow (containing small bubbles) into a coarse 2-phase flow (containing larger bubbles). That is to say, the process makes small bubbles into larger bubbles).

A further phase ‘segregation’ stage, using gravity or centrifugal force, can bring about true, or complete, separation (by using a segregator apparatus such as a settling chamber, cyclone, helix, etc.)

LEM-assisted coalescence prior to phase segregation by gravity or centrifugal force has an advantageous technical effect that segregation is achieved, overall, more easily and this allows the use of segregation apparatus or ‘plant’ which is smaller and consumes less energy. Hence, LEM-assisted gas-liquid separation is envisaged by the inventors as a two stage process involving, i) (enhanced) coalescence and, ii) phase segregation.

Also, as mentioned earlier herein, phase segregation apparatus for froth destruction/segregation, such as a cyclone or helix, can be improved by lining the interior surface of the phase segregation apparatus with expanded mesh, as will be explained further below (see Table 1 on the next page for test results).

TABLE 1

| | Mesh Materials | | Volume, | DeltaP, | Froth |
|---|---|---|---|---|---|
| Configuration | Primary | Secondary | mL | mbar | Destruction, % |

Cyclone Enhancement

| | | | | |
|---|---|---|---|---|
| Cyclone | None | 1770 | 0 | 0 |
| Cyclone | ET8300 | 1770 | 0 | 25 |
| (mesh lined) | | | | |

Primary - Radial Pleats

| | | | | | |
|---|---|---|---|---|---|
| 8 pleats | ET8300 | None | 314 | 93 | 93 |

Primary - Parallel Pleats

| | | | | | |
|---|---|---|---|---|---|
| 9 pleats | ET8300 | None | 200 | 63 | 95 |
| (x4 elements) | | | | | |

Primary - Parallel Streamers

| | | | | | |
|---|---|---|---|---|---|
| x7 Streamers | ET8300 | None | 100 | 38 | 73 |
| (x1 element) | | | | | |
| x7 Streamers | ET8300 | None | 200 | 73 | 94 |
| (x2 element) | | | | | |
| x5 Streamers | PTFEKM22001 | None | 226 | 68 | 91 |
| (x2 elements) | | | | | |
| x7 Streamers | 5PTFE7-100ST | None | 100 | 60 | 83 |
| (x1 element) | | | | | |
| x7 Streamers | 5PTFE7-100ST | None | 200 | 76 | 97 |
| (x2 element) | | | | | |

Secondary

| | | | | | |
|---|---|---|---|---|---|
| x7 Screens | None | PTFEKM22001 | 4500 | 8 | 95 |
| x7 Screens | None | ET8300 | 4500 | 0 | ~100 |
| x7 Screens | None | 5PTFE7-100ST | 4500 | 8 | ~100 |

Primary and Secondary

| | | | | | |
|---|---|---|---|---|---|
| x7 Streamers | ET8300 | 5PTFE7-100ST | 4600 | 53 | ~100 |
| (x1 element) | | | | | |
| & x7 Screens | | | | | |
| x7 Streamers | ET8300 | 5PTFE7-100ST | 4700 | 78 | ~100 |
| (x2 element) | | | | | |
| & x7 Screens | | | | | |

The concept of primary and secondary bubble coalescence will now be explained.

Investigation by the inventors has led to the development of primary and secondary LEM bubble coalescing devices or coalescers (see FIG. 16). A coalescer may be termed a ‘Bubble Catching device’ or ‘Bubble Trap(ping) device’.

### Primary Coalescer Apparatus

The primary coalescer device or apparatus can be mounted within a pipe downstream from the gas-liquid contactor of a fuel cell system. Examples are shown in FIGS. 15 and 19 and are described further below. The primary coalescer device can be placed upstream of a secondary coalescer device or apparatus, as illustrated in FIG. 16 and described further below.

The primary coalescer device comprises multiple (typically mesh) surfaces mounted at least partially parallel to the flow stream. This arrangement has the following advantages:

i) it minimises impedance of the flow stream (i.e. it provides lower pressure drop and lower energy consumption) due to the parallel mounting of the surfaces, and
ii) it takes advantage of crossflow shear action, in which the fluid courses, or is directed, across the low-energy surface, in a direction at least partially parallel to the surface of the LEM, in order to sweep or drag larger coalesced bubbles from the active surface of the LEM.

Coursing, or directing, the fluid flow across the surface, as described above, enables exposure or contact of the incoming finer bubbles with the surface of the LEM.

Without a shear action as described above, which acts to tear or drag the bubbles away from the surface, the only mechanism for bubble removal is buoyancy of the bubbles relative to the liquid, due to their lower density compared to that of the liquid.

If buoyancy is the only mechanism, the active surface becomes isolated from a significant portion of the bubbles by an established gas layer resulting from many coalesced bubbles forming a single volume of gas. As a result the process of gas-liquid separation or segregation is less effective.

In addition, crossflow shear action has also been observed to encourage bubbles to grow by coalescing, or merging, with one another in a ‘snowball-like’ fashion as they are swept downstream across the surface, which typically comprises a mesh structure.

Surfaces may be mounted across the pipe cross section in parallel to one another, or radially, and/or in pleats.

FIG. 15 illustrates some example parallel (155) and radial (157) configurations. Each LEM surface 1551, 1571 may be secured in place along all its perimeter or edges, or the surface may only be secured along, or proximal to, its upstream portion e.g. local to its upstream edge, the trailing edge(s) being free, thereby allowing the surfaces, when they are made of flexible material, to behave ‘streamer-like’ in the flow field (see FIGS. 16 to 18). This allows the surfaces a degree of mobility. Turbulence of the fluid flowing past the surfaces is thus able to disturb each streamer, improving contact and also improving bubble detachment.

The primary coalescer may be designed and arranged as a series of discrete ‘elements’ within a pipe. Each element would contain and support a suitable amount of LEM surface. If one element was found to be insufficient to coalesce a given flow or fineness of froth, then plural elements could be installed as required. FIG. 19 illustrates an example of a fluid pipe containing plural (three) such bubble-coalescing elements 191, 192 and 193 spaced along the direction of fluid flow 194. To improve contact, one element 192 could be mounted with an angle of axial rotation differing from one or more other element(s) 191, 193 so that the LEM surfaces of respective elements are rotationally offset from each other about the direction of fluid flow or the pipe main axis 194).

In FIG. 16, an example primary coalescing device 1620 comprises primary coalescing elements 1622 within a froth inlet pipe 1630 which inputs froth to an example secondary coalescing apparatus 1600 having a secondary coalescer device 1605 within a reservoir 1606 for containing gas and liquid phases, a froth input 1640 for inputting froth from the pipe to the secondary coalescing device 1605, a gas outlet 1642 and a liquid outlet 1644.

### Secondary Coalescer

The example secondary coalescer device 1605 or ‘Bubble Trap’ is mounted within the reservoir 1606 and receives return (fluid) flow via the primary device 1620. The main purposes of the secondary coalescer device 1605 are

i) to contain and coalesce any bubbles escaping the primary device and,
ii) to calm the incoming flow stream, thus containing and destroying any re-entrainment.

The example secondary coalescer device 1605 is illustrated in both FIGS. 16 and 17. The device 1605 consists of a rack 1605 comprising an array of vertical mesh screens 1602 alongside one another, each screen held and sealed along, or proximal to, at least part of its perimeter, e.g. along its side and lower edges (as shown in FIG. 17), within a rack mounting 1702, the device 1605 being shown in FIG. 16 within the fluid reservoir 1606 of the secondary coalescing apparatus 1600. The rack 1605 is open at its input (upper, as shown) end or roof and at least one of the outer faces 1704 of the rack 1605 is parallel to the mesh screens 1602, other faces 1706 being impermeable to fluid flow. Fluid flow enters the array of screens as a downwardly flowing jet 1616 from above the secondary apparatus 1600 and from above device 1605. As the flow drains laterally through the screens 1602, the gas within the gas-liquid fluid mixture 1608, within the reservoir 1606, disengages and the liquid within the gas-liquid fluid mixture 1608 eventually exits via the open rack face(s) 1704. FIGS. 16 and 17 together serve to illustrate this arrangement. A useful feature, shown in the example coalescer of FIGS. 16 and 17, is that each screen can be supported along, or proximal to, its upper or leading perimeter or edge(s) 1610 so as to resist deformation by the downward jetting flow of the fluid which is input to the secondary coalesce, indicated by arrow 1616.

FIG. 18 shows another example secondary coalescer device 1800 comprising a container 1801 having circular cross section and an open screen arrangement in which the vertical mesh screens 1802 are not fixed at their sides 1812 but are only fixed at or near their upper edges 1810. The screens 1802 can therefore move laterally to the fluid flow direction (from top to bottom in FIG. 18) to a greater extent than the screens of the example shown in FIGS. 16 and 17, in particular they can move more at or towards their lower (liquid output-side) edges 1813.

The rack 1605 of the example arrangement shown in FIG. 16 has screens that are attached, at their lower edges (towards the liquid output end of the apparatus 1600), to a liquid- and gas-impermeable closed surface or plate 1607 which prevents liquid within foam 1614, between adjacent screens 1602, from exiting the rack 1605 downwards towards the liquid output end (lower end in the figure) of the apparatus 1600, and helps to direct the liquid that has passed between the screens, laterally out from the rack 1605 and into the fluid surrounding the rack 1605, as indicated by arrows 1650.

There are at least three mechanisms for this very effective means of froth destruction.

First according to a first mechanism, as described for the primary coalescer, destruction begins as the froth moves or courses across the LEM surface during its initial passage (the flow direction of froth being shown as downward in FIG. 16 and horizontal in FIG. 19) into the array of primary coalescer elements 1622, 191-3.

The primary coalescer elements 1622, 191 to 193 are typically mesh screens since such mesh screens have been found to give good results.

Secondly, the screens 1602 of the secondary coalescer device 1605 inhibit any surviving froth from advancing laterally with respect to the main fluid flow direction (indicated by arrow 1616 in FIG. 16).

De-gassed liquid is allowed to drain through apertures of the screens 1602. However, bubbles larger than these apertures are prevented from passing through the apertures (typically mesh) and are detained or held up until they are collapsed or burst.

Bubbles smaller than the apertures can pass though the apertures with the liquid. However, most of the bubbles are prevented from reaching the screen surface by the detained larger bubbles. This can be considered as advantageous in that, in effect, the screen or mesh acts like a bubble filter with the retention of smaller bubbles (within the regions between adjacent screens) being assisted by a ‘filter cake’ of larger bubbles in a region between the region containing the smaller bubbles and the surface of the screen facing that region (not illustrated).

A third mechanism may arise due to a flow field existing beneath the fluid-plunging inlet of the secondary coalesce device.

FIG. 20 illustrates this. Re-circulation eddies 2002 form as the inflowing fluid froth 2004 plunges into a mesh array 2006. Due to their size, small bubbles 2007 become trapped within these eddies 2002 and are thus repeatedly re-circulated (as shown by the circular arrows 2002) and re-exposed to the surface of the mesh array 2006. Hence, the small bubbles 2007 are selectively retained and re-worked until they are sufficiently large (shown by bubble 2008) that their buoyancy allows them to escape to the surface (as shown by arrows 2015 and bubbles 2009, 2010) where the large bubbles 2008, 2010 burst or break (collapse) as indicated by bursting bubble 2011.

It is envisaged that the combination of these three mechanisms makes the LEM bubble trap very effective, test results indicating this effectiveness.

Without the presence of a secondary coalescing device or ‘Bubble Trap’, gravity separation (by upward floating movement of buoyant bubbles within, and relative to, the liquid) would be the only mechanism available to facilitate (a) the destruction/containment of residual froth and (b) gas re-entrainment in the liquid fluid. If such gravity separation is the only mechanism, the gas-liquid [segregation] reservoir would therefore need to be much larger than if the secondary coalescing device is used. Clearly, the secondary coalescing device provides for use of a smaller reservoir for a given fluid flow rate and a given.

In addition to primary and secondary coalescer stages as described above, the gas-liquid separator system could also be arranged with primary and secondary gas-liquid segregation stages.

For example, following the primary coalescer, gas-liquid mixed fluid flow could be directed to a cyclone or helix or other bulk separator to facilitate bulk segregation of the gas phase from the liquid phase. Liquid (and any residual froth) discharging from the bulk separator liquid output (e.g. cyclone base or helix output) could then be directed to a secondary coalescer bubble trap. Gravity settling within the gas-liquid reservoir would then facilitate secondary segregation.

The advantages of such an arrangement may become apparent on higher-power systems employing high flow rates and/or high flow velocities. Separation by staged coalescence and segregation would allow flow velocities to be gradually reduced before return of the fluid to the reservoir. This would further promote calming of flow and would avoid secondary entrainment to the gas and liquid outlets respectively.

Testing of LEM mesh materials, carried out by the inventors, will now be described.

A range of LEM meshes and surfaces have been investigated by the inventors in order to determine their effectiveness. Results are given in Table 2 immediately below. Knitted Mesh PTFEKM22001 and Expanded Meshes ET-8300 and 5PTFE7-100ST were selected for testing and were found to give good performance.

TABLE 2

| Material | Supplier |
|---|---|
| PTFE Felt (PTFENF18005) | Textile Development |
| | Associates, Inc., USA |
| PTFE Expanded Mesh (ET-8300) | Industrial Netting, USA |
| PTFE Expanded Mesh (ET-8700) | Industrial Netting, USA |
| PTFE Expanded Mesh (ET-9000) | Industrial Netting, USA |
| PTFE Knitted Mesh (PTFEKM22003) | Textile Development |
| | Associates, Inc., USA |
| PTFE Knitted Mesh (PTFEKM22005) | Textile Development |
| | Associates, Inc., USA |
| PTFE Solid Sheet | theplasticshop.co.uk |
| PTFE Knitted Mesh (PTFEKM22001) | Textile Development |
| | Associates, Inc., USA |
| PTFE Expanded Mesh (5PTFE7-100ST) | Dexmet Inc., USA |
| PTFE Expanded Mesh (5PTFE9-077ST) | Dexmet Inc. |
| PTFE Expanded Mesh (5PTFE6-050ST) | Dexmet Inc. |
| PTFE Expanded Mesh (15PTFE16-077ST) | Dexmet Inc. |
| PTFE Expanded Mesh (10PTFE20-100DBST) | Dexmet Inc. |

Images of knitted mesh PTFEKM22001 (originally developed for surgical applications) are shown in FIG. 21 and another mesh is shown in FIG. 22. In the figures, expanded mesh 2102 consists of a single sheet 2102 of material which has been formed (e.g. machined or moulded) with regular diamond shaped apertures 2104. The end result is a continuous and consistent, ‘lint-free’ mesh of interconnected fine strands 2206 which will not shed (come away from the mesh) when cut (unlike knitted or woven meshes which can release severed strand ends into the flow stream). FIG. 22 and Table 3, below, together present the form and dimensions of the expanded mesh.

TABLE 3

| | | | | | Nominal | |
|---|---|---|---|---|---|---|
| | | | | | Aperture, | |
| | | | | | mm | |
| | LWD, | SWD, | Thickness, | Strand | Long | Short |
| Material | mm | mm | mm | width, mm | axis | Axis |
| ET8300 | 1.91 | 1.22 | 0.46 | 0.36 | 1.14 | 0.64 |
| 5PTFE7-100ST | 2.54 | 0.99 | 0.13 | 0.18 | 1.80 | 0.66 |

As the process of LEM-assisted bubble coalescence is a surface phenomenon (i.e. it occurs at a surface), self supporting meshes could be fabricated with a rigid substructure (e.g. wire mesh coated with PTFE). External supporting structures (e.g. racks, frames, supporting ribs, etc.) take up volume, are intrusive to flow and thus contribute to pressure drop along the fluid flow direction. An internal supporting structure would avoid these problematic issues.

Primary and secondary coalescer devices, as described above, were developed by the inventors though a program of testing and development. Devices were tested downstream of a froth generator. Unless otherwise stated, applied fluid flows were 30 L/min (0.5 litres per second) catholyte and 120 L/min (2 litres per second) air at room temperature (around 20 degrees Celsius). Table 3 summarises each prototype design and performance.

### Mist Prevention

During tests, the above described devices were also found to generate much less catholyte mist carryover to the gas exhaust (i.e. less droplets escaping with exiting or output gas). Results of the tests indicate that it is possible, by use of the invention, to obtain two orders of magnitude improvement over conventional gravity and centrifugal froth separation devices (i.e. settling chamber, cyclones, helix etc.)

### Explanation for LEM Mist Prevention

The following provides a proposed explanation of why a LEM-based gas-liquid separator, examples of which are described above, releases significantly less catholyte mist to the exhaust stream than by gravity or centrifugal based techniques.

### Gravity and Centrifugal Based Gas-Liquid Separation

Settling chambers, cyclones and helices all exploit differences in phase density to achieve gas-liquid separation and thereby froth collapse. Gravity or centrifugal force is used to induce liquid drainage via the froth's interconnected network of bubble membranes. As a result, bubbles at the froth surface become liquid starved, leading to membrane thinning and therefore weakening. Eventually the weaken membranes rupture under the influence of surface tension. Liquid surface tension then draws the collapsing membrane films into spherical droplets. These become entrained within the separating gas stream and exit the system via the gas exhaust output. This is udesirable. A new surface layer of bubbles is consequently revealed on the upper surface of the froth or foam and the process repeats.

LEM Based Gas-Liquid Separation, Compared with Gravity and Centrifugal Based Gas-Liquid Separation:

Due to the hydrophobic nature of PTFE or other low-surface energy material, each liquid bubble membrane contacts the low-energy surface with a low′ contact angle. That is, the outer surface of the bubble's membrane is repelled by the hydrophobic surface and therefore, when the bubble contacts the surface, its membrane becomes angled away more from the surface outwardly from the central point of contact of the bubble with the surface, than if the surface were made of a higher-surface energy material. In other words, the surface of the bubble membrane, in the region of contact of the membrane with the surface, is more outwardly convex than it would be if the surface were made of a higher-surface energy material.

This ‘low’ contact angle acts to undermine and locally thin the membrane at the point of contact, leading to weak surface adhesion. Inherent membrane surface tensions then become sufficient to tear or drag the liquid film membrane away from the PTFE surface and thereby remove the bubble from the surface. As each membrane retracts, liquid, contained within the membrane, flows into surrounding films of one or more other bubbles and two bubbles are coalesced into one. See FIGS. 12 to 14 consecutively.

According to the above-described process of destruction or coalescence of bubbles by means of low-surface energy material, which might be termed ‘scrubbing’ but is not limited by any use of such term, in a general sense the bubble membranes are not weakened by drainage of the liquid, the integrity of the membranes is maintained as the membranes retract and as such, each membrane is much less likely to disintegrate into droplets. That said, even if some droplets are created anyway, despite this maintained integrity of the membranes, the formation of such droplets would occur as a double encapsulation and would occur beneath a blanket or region of froth. This provides opportunity for re-absorbsion of the droplets thus preventing the droplets from being released to the gas output or exhaust.

1. A separator for a liquid electrolyte regenerator of a fuel cell system, the separator comprising a helical channel in the form of a fluid channel formed on a helix and arranged to conduct a gas-liquid mixture and separate liquid from the gas-liquid mixture.

2. The separator of claim 1 wherein the overall helical diameter (D_{Helix}) of the helical channel is close to twice the hydraulic diameter (Dₚᵢₚₑ) of the helical channel along at least a portion of the helical channel.

3. The separator of claim 1, comprising a porous element, located at an exterior wall region of the helical channel, through which gas can pass.

4. The separator of claim 1, comprising a porous element located at an interior wall region of the helical channel, through which gas can pass.

5. The separator of claim 1, wherein the helical channel has a surface comprising a low surface energy material and arranged to contact the gas-liquid mixture.

6. The separator of claim 5, wherein the surface is provided at least partly on a holed member in the channel, holes in the holed member arranged to allow the gas-liquid mixture to pass through the holes.

7. The separator of claim 6, wherein the holed member is in the form of a mesh or perforated plate.

8. The separator of claim 6, wherein the holed member has holes having diameters between 0.1 millimetre and 10 millimetres.

9. The separator of claim 6, wherein the holed member extends across the internal diameter of the helical channel.

10. The separator of claim 1, comprising a further helical channel formed on a smaller-diameter helix and in fluid communication with the helical channel, the further helical channel being arranged to conduct liquid and gas of a portion of the gas-liquid mixture that passes from the helical channel to the further helical channel and to separate liquid from the portion of the gas-liquid mixture.

11. The separator of claim 10, wherein the further helical channel has a surface comprising a low surface energy material.

12. The separator of claim 10, wherein the further helical channel comprises heat conductive material and is surrounded by the helical channel, the further helical channel being for conducting a fluid colder than said gas-liquid mixture.

13. The separator of claim 10, wherein the helical channel and/or or the further helical channel comprises a non-smooth outer surface.

14. The separator of claim 1, wherein the helical channel comprises plural channels formed on respective plural helices substantially parallel to each other.

15. The separator of claim 14, wherein the plural helices have separate longitudinal axes.

16. The separator of claim 1, wherein the overall helical diameter and the hydraulic diameter of the helical channel are graduated along the helical channel between an inlet having larger overall helical diameter and larger hydraulic diameter and an outlet having smaller overall helical diameter and smaller hydraulic diameter.

17. The separator of claim 1, comprising a gas vent between the helical channel and an inner core surrounded by the helical channel, allowing separated gas to pass through the gas vent between the helical channel and the inner core.

18. The separator of claim 17, wherein the gas vent comprises a hydrophobic material having pores or micro-pores for inhibiting passage of liquid through the pores and allowing passage of gas through the pores.

19. The separator of claim 1, wherein the helical channel comprises a first helical channel for separating liquid from the gas-liquid mixture to produce bulk liquid-phase liquid and gas, and a second helical channel, coupled to the first helical channel, for separating vapor-phase liquid and entrained liquid phase liquid from the gas.

20. The separator of claim 1, wherein the gas-liquid mixture comprises liquid in the vapor phase.

21. The separator of claim 1, wherein the separator comprises a bulk separator for performing separation of a gas-liquid mixture comprising liquid in liquid-phase, a demister for performing separation of a gas-liquid mixture comprising liquid in both liquid-phase and vapour-phase, and a condenser comprising an air-air plate heat exchanger for performing separation of a gas-liquid mixture comprising liquid in vapor-phase, wherein at least one of the bulk separator, the demister and the condenser has a helical channel.

22. A separator and regenerator apparatus comprising the separator of claim 1 and a regenerator arranged to input liquid electrolyte and gas to generate gas bubbles in the liquid electrolyte and output the liquid and gas in bubble form.

23. A generator of heat and power comprising a separator for a liquid electrolyte regenerator of a fuel cell system of claim 1, for the combined generation of heat and power.

24. A vehicle comprising fuel cell system of claim 23 to provide motive power to the vehicle.

25. An electronic component comprising fuel cell system of claim 23 to generate power in the electronic component.

26-28. (canceled)

29. A foam reduction apparatus comprising a low surface energy material and means for contacting foam, when said foam is input to the foam reduction apparatus, along a surface of said low surface energy material.

30. An apparatus as claimed in claim 29, wherein at least a portion of the surface of said low surface energy material is convex or pointed so that it is projecting away from other portions of the surface.

31. An apparatus as claimed in claim 30, wherein the portion is formed by plural convex regions on the surface.

32. An apparatus as claimed in claim 30, wherein the portion is formed by elongate strands of a mesh structure.

33. An apparatus as claimed in claim 29, wherein the surface is oriented at least partly parallel to a direction of flow of fluid past the surface.

34. An apparatus as claimed in claim 29, wherein the surface is of flexible material and is held at or proximal to its upstream end, so as to inhibit movement of its upstream end whilst permitting lateral movement of a portion of the surface distal from its upstream end.

35. An apparatus as claimed in claim 29, wherein the surface comprises a plurality of surfaces which are held in position proximal to one another so that they are at least partly parallel to one another and to the primary direction of fluid flow at their respective upstream ends.

36. An apparatus as claimed in claim 35, wherein the plurality of surfaces are held in position so that they are spaced apart from one another in a direction transversal to the primary direction of fluid flow.

37. An apparatus as claimed in claim 35, wherein the plurality of surfaces are attached to one another along an axis at least partly parallel to the primary direction of fluid flow and held in position so that they each extend from said axis radially outward from said axis.

38. A gas-liquid separating apparatus comprising a separator as claimed in claim 1, and a foam reduction apparatus comprising a low surface energy material and means for contacting foam, when said foam is input to the foam reduction apparatus, along a surface of said low surface energy material.

39. A generator of heat and power comprising a fuel cell system comprising an apparatus as claimed in claim 29 for the combined generation of heat and power.

40. A vehicle comprising the generator of heat and power as claimed in claim 39 to provide motive power to the vehicle.

41. An electronic apparatus comprising fuel cell system in claim 29 to generate power in the electronic apparatus.
